(19) United States
(12) Patent Application Publication
(10) Pub. No.: US 2014/0316904 A1
(43) Pub. Date: Oct. 23, 2014

(54) E-commerce advertising method with dynamic bid decrease and concealed bid time frame

(71) Applicants: Mu-Chen Chen, Taipei (TW); Yi-Ching Tseng, New Taipei City (TW)

(72) Inventors: Mu-Chen Chen, Taipei (TW); Yi-Ching Tseng, New Taipei City (TW)

(21) Appl. No.: 14/318,692

(22) Filed: Jun. 30, 2014

(51) Int. Cl. G06Q 30/02

(52) U.S. Cl. CPC G06Q 30/0275
USPC 705/14.71

(57) ABSTRACT

An e-commerce advertising method is provided with creating an e-commerce advertising website having web pages each including a product and service advertising region and a promotional product bidding region. The promotional product bidding region includes a graphical and textual overview of a promotional product, a supplier hyperlink, and a predetermined bid displayed in the promotional product bidding region, and a bid time frame of the promotional product is set. With the concealed bid time frame, dynamic bid decrease is performed so that network users cannot predict the price decrease time of the promotional product, but need to browse the e-commerce advertising website all the time to monitor the price change in order to bid the promotional product with a lower price.

### BACKGROUND OF THE INVENTION

1. Field of the Invention

The invention relates to an e-commerce advertising method, and more particularly to an e-commerce advertising method with a dynamic bid decrease and a concealed bid time frame.

2. Description of Related Art

In conventional network bidding mechanisms, a seller provides an auction product and generally gives a starting bid price for buyers to compete bidding for the auction product. If one of the buyers wants to buy the product successfully, the buyer has to compete with other buyers continuously, so that the selling price of the product is rising continuously until the buyer has won the bid buyer. Since the starting bid price of the product is controlled by the seller, the seller can make a certain profit, but the buyer has to offer and accept a higher price in order to win the bid, or else the buyer is unable to win the bid. As to the buyer, bidding is unfavorable to the buyer, and thus such bidding cannot attract too many network users to compete bidding in an auction, and most buyers start competing within a short time before the auction is closed to avoid raising the auction price too high. Naturally, the network buyers need not to spend too much time to browse or pay attention to other commercial advertising and information on the auction web page.

Thus, the need for improvement still exists.

### SUMMARY OF THE INVENTION

It is therefore one object of the invention to provide an e-commerce advertising method comprising the steps of (a) creating an e-commerce advertising website comprising a plurality of web pages each including a plurality of product and service advertising regions and a promotional product bidding region wherein each of the product and service advertising regions includes a graphical and textual overview of a promotional product and a supplier hyperlink which are displayed on each of the product and service advertising regions; the promotional product bidding region includes a graphical and textual overview of a promotional product, a supplier hyperlink, and a predetermined bid of promotional product; and the promotional product has a bid time frame and a bid status set as a bidding status; (b) if the bid status of the promotional product is the bidding status, allowing each of a plurality of network users to offer a bid of the promotional product for an auction within the bid time frame of the promotional product; (c) if the bid is equal to the predetermined bid of the promotional product, setting the bid as a valid bid, setting time of offering the bid as a bidding time, and setting the network user offering the bid as a product bidder; (d) after the bid time frame of the promotional product ends, setting the product bidder offering the bid equal to the predetermined bid of the promotional product at an earliest time as a bid winner of the promotional product, and setting the bid status of the promotional product as a bid winning status; (e) if the bid status of the promotional product is the bid winning status, noticing the product bidder by an email or a short message and informing the product bidder about a bid winning of the promotional product; (f) if none of the network users bids the promotional product within the bid time frame of the promotional product, and none of the valid bids exists, setting the bid status of the promotional product as a status of bid failure; and (g) if the bid status of the promotional product is the status of bid failure, decreasing the predetermined bid of the promotional product by a predetermined amount, setting the decreased bid of the promotional product as a predetermined bid of the promotional product, resetting both the bid time frame and the bid status of the promotional product wherein the bid status of the promotional product is set as a bidding status, and repeating steps (b) to (f) until the predetermined bid of the promotional product is equal to or less than zero.

The above and other objects, features and advantages of the invention will become apparent from the following detailed description taken with the accompanying drawings.

### BRIEF DESCRIPTION OF THE DRAWINGS

FIG. 1 schematically shows a network incorporating an e-commerce advertising method of the invention.

### DETAILED DESCRIPTION OF THE INVENTION

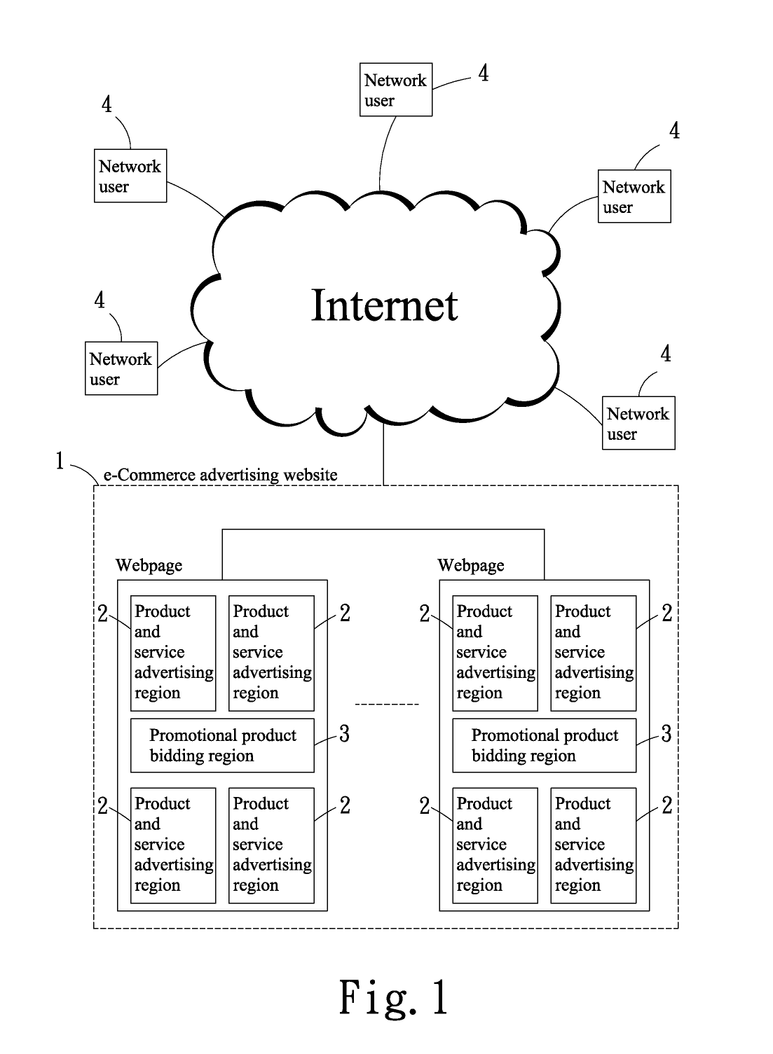

Referring to FIG. 1, an e-commerce advertising method with a dynamic bid decrease and a concealed bidding deadline in accordance with the invention is illustrated. The method comprises the steps of creating an e-commerce advertising website 1 comprising a plurality of web pages each having a plurality of product and service advertising regions 2 and a promotional product bidding region 3, wherein the product and service advertising region 2 includes a graphical and textual overview of a promotional product and a supplier hyperlink which are displayed in the product and service advertising region 2; the promotional product bidding region 3 includes a graphical and textual overview of a promotional product, a supplier hyperlink and an predetermined bid which are displayed in the promotional product bidding region 3; and the promotional product includes a bid time frame and a bid status; wherein the bid status is set to be a bidding status.

If the bid status of the promotional product of the promotional product bidding region 3 is set to be the bidding status, and any one of the network users 4 bids the promotional product in the promotional product bidding region 3 within the bid time frame of the promotional product, and the bid is equal to the predetermined bid of the promotional product, then the bid will be set as a valid bid, and the corresponding bidding time will be set as a bid offering time, and the network user 4 will be set as a product bidder.

After the bid time frame of the promotional product in the promotional product bidding region 3 ends, the product bidder offers the bid in the earliest time is the bid winner of the promotional product, and the bid status of the promotional product is set as a bid winning status.

If none of the network users 4 bids the promotional product in the promotional product bidding region 3 within the bid time frame of the promotional product, and none of the valid bids exists, then the bid status of the promotional product will be set as a status of bid failure.

If the bid status of the promotional product in the promotional product bidding region 3 is the bid winning status, then the e-commerce advertising website 1 will notice the product bidder via an email or a short message and inform the product bidder with regard to the bid winning of the promotional product.

If the bid status of the promotional product in the promotional product bidding region 3 is the status of bid failure, then the e-commerce advertising website 1 will decrease the predetermined bid of the promotional product in the promotional product bidding region 3 by a predetermined money by running a program and will reset the bid time frame and the bid status of the promotional product, wherein the bid status will be set to be a bidding status. It is noted that the network users 4 are not aware when will the predetermined bid of the promotional product decrease and the decreased predetermined bid.

Steps in the above four paragraph will be repeated until the predetermined bid of the promotional product in the promotional product bidding region 3 is equal to or less than zero.

It is envisaged by the invention that for any network user 4 who wants to bid the promotional product in the promotional product bidding region 3, the network user 4 does not know the bid time frame of the promotional product and cannot predict the time when the predetermined bid of the promotional product decreases. Thus, the network user 4 has to monitor the change of the predetermined bid of the promotional product all the time. Thus, the network user 4 can bid the promotional product as soon as the predetermined bid decreases to a price acceptable by the network user 4. As a result, it can increase the possibility of winning the bid of the promotional product.

Therefore, the graphical and textual overview of the promotional products in the product and service advertising regions 2 of the web page of the e-commerce advertising website 1 can be browsed and read repeatedly by many network users 4 in order to increase exposure and publicity of the promotional products, so as to maximize the beneficial effect of the commercial advertising of the e-commerce advertising website 1.

While the invention has been described in terms of preferred embodiments, those skilled in the art will recognize that the invention can be practiced with modifications within the spirit and scope of the appended claims.

What is claimed is:

1. An e-commerce advertising method comprising the steps of:
(a) creating an e-commerce advertising website comprising a plurality of web pages each including a plurality of product and service advertising regions and a promotional product bidding region wherein each of the product and service advertising regions includes a graphical and textual overview of a promotional product and a supplier hyperlink which are displayed on each of the product and service advertising regions; the promotional product bidding region includes a graphical and textual overview of a promotional product, a supplier hyperlink, and a predetermined bid of the promotional product; and the promotional product has a concealed bid time frame and a bid status set as a bidding status;
(b) if the bid status of the promotional product is the bidding status, allowing each of a plurality of network users to offer a bid of the promotional product for an auction within the bid time frame of the promotional product;
(c) if the bid is equal to the predetermined bid of the promotional product, setting the bid as a valid bid, setting time of offering the bid as a bidding time, and setting the network user offering the bid as a product bidder;
(d) after the bid time frame of the promotional product ends, setting the product bidder offering the bid equal to the predetermined bid of the promotional product at an earliest time as a bid winner of the promotional product, and setting the bid status of the promotional product as a bid winning status;
(e) if the bid status of the promotional product is the bid winning status, noticing the product bidder by an email or a short message and informing the product bidder about a bid winning of the promotional product;
(f) if none of the network users bids the promotional product within the bid time frame of the promotional product, and none of the valid bids exists, setting the bid status of the promotional product as a status of bid failure; and
(g) if the bid status of the promotional product is the status of bid failure, decreasing the predetermined bid of the promotional product by a predetermined amount, setting the decreased bid of the promotional product as a predetermined bid of the promotional product, resetting both the bid time frame and the bid status of the promotional product wherein the bid status of the promotional product is set as a bidding status, and repeating steps (b) to (f) until the predetermined bid of the promotional product is equal to or less than zero.
